(19) United States
(12) Patent Application Publication
(10) Pub. No.: US 2025/0309755 A1
(43) Pub. Date: Oct. 2, 2025

(54) OPTIMAL EFFICIENCY DRIVEN POWER FACTOR CORRECTION CONVERTER

(71) Applicant: STMicroelectronics International N.V., Geneva (CH)

(72) Inventors: Dino COSTANZO, Catania (IT); Weilong ZHENG, Shenzhen (CN); Chengpan CAI, Shenzhen (CN)

(21) Appl. No.: 19/080,231

(22) Filed: Mar. 14, 2025

(30) Foreign Application Priority Data
Mar. 29, 2024 (CN) 202410375223.X

(51) Int. Cl. H02M 1/42; H02M 1/12

(52) U.S. Cl. CPC H02M 1/4225; H02M 1/12; H02M 1/4216

(57) ABSTRACT

Apparatuses, systems, and methods for power factor correction (PFC) converters are provided, including PFC converters driven at optimal efficiencies. An exemplary PFC converter may comprise input circuitry receiving an input voltage, output circuitry providing an output voltage, a boost circuitry electrically coupled to the input circuitry and output circuitry, and a switch. The boost circuitry includes a capacitor. The switch is configured to operate in an on state and an off state and operating in the on-state causes charging of the capacitor and operating in the off-state causes discharging of the capacitor. A PFC converter controller control the switch to change states at a first ratio associated with one or more time periods for the on state and one or more periods for the off state, and the first ratio also associated with a first efficiency threshold associated with the on state.

### CROSS REFERENCE TO RELATED APPLICATIONS

This application claims the priority benefit of Chinese Patent Application No. 202410375223.X, filed on Mar. 29, 2024, entitled “OPTIMAL EFFICIENCY DRIVEN POWER FACTOR CORRECTION CONVERTER,” which is hereby incorporated by reference to the maximum extent allowable by law.

### TECHNOLOGICAL FIELD

Example embodiments of the present disclosure relate generally to power factor correction (PFC) converters, particularly for PFC converters driven at optimal efficiencies.

### BACKGROUND

The power factor of an AC power system is a ratio of real power absorbed by a load to an apparent power flowing in a circuit. Multiple applications use power factor correction (PFC) to adjust a power factor and/or total harmonic distortion (THD) in a signal that drives a load (e.g., a motor). A PFC converter may convert an alternating current (AC) input voltage and generate a direct current (DC) output voltage that drives one or more loads (e.g., motors). PFC may be used with steady state loads as well as load that vary with time, which may be referred to as variable loads. For example, a fan may run at a constant speed and/or may change speeds, and the motor driving the fan may be a load that may stay the same or change over time.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to apparatus, systems, and methods for PFC converters particularly for PFC converters driven at optimal efficiencies.

In accordance with some embodiments of the present disclosure, an example power factor correction converter is provided. The example power factor correction converter comprises: an input circuitry to receive at least an input voltage; an output circuitry to provide an output voltage; a boost circuitry electrically coupled to the input circuitry and to the output circuitry, wherein the boost circuitry comprises at least one capacitor; at least one switch, wherein the at least one switch is in the input circuitry or the boost circuitry, wherein the at least one switch is configured to operate in at least two states including an on state and an off state, wherein operating in the on state causes the boost circuitry to charge the at least one capacitor and wherein operating in the off state causes the at least one capacitor to discharge; and a power factor correction converter controller configured to control the at least one switch to change states between the on state and the off state at a first ratio, wherein the first ratio is associated one or more time periods for the on state and one or more periods for the off state and also with a first efficiency threshold associated with the on state.

In some embodiments, the first efficiency threshold is associated with an optimal power factor efficiency.

In some embodiments, the input voltage comprises a single-phase voltage input.

In some embodiments, the input voltage comprises a three-phase voltage input.

In some embodiments, the power factor correction converter controller is further configured to determine the first ratio based on a current load associated with the power factor correction converter.

In some embodiments, the power factor correction converter controller is further configured to determine the first ratio based on a predicted load.

In some embodiments, the power factor correction converter controller is further configured to determine the first ratio based on a load profile.

In accordance with some embodiments of the present disclosure, an example system is provided. The example system comprises: a power source; a load; a power factor correction converter comprising: an input circuitry coupled to the power source and configured to receive an input voltage from the power source; an output circuitry coupled to the load and configured to provide an output voltage to the load; a boost circuitry electrically coupled to the input circuitry and to the output circuitry, wherein the boost circuitry comprises at least one capacitor; at least one switch, wherein the at least one switch is in the input circuitry or the boost circuitry, wherein the at least one switch is configured to operate in at least two states including an on state and an off state, wherein operating in the on state causes the boost circuitry to charge the at least one capacitor and wherein operating in the off state causes the at least one capacitor to discharge; and; and a power factor correction converter controller configured to control the at least one switch to change states between the on state and the off state at a first ratio, wherein the first ratio is associated one or more time periods for the on state and one or more periods for the off state and also with a first efficiency threshold associated with the on state.

In some embodiments, the first efficiency threshold is associated with an optimal power factor efficiency.

In some embodiments, the voltage input comprises a single-phase input voltage.

In some embodiments, the voltage input comprises a three-phase input voltage.

In some embodiments, the power factor correction converter controller is further configured to determine the first ratio based on a current load associated with the power factor correction converter.

In some embodiments, the power factor correction converter controller is further configured to determine the first ratio based on a predicted load.

In some embodiments, the power factor correction converter controller is further configured to determine the first ratio based on a load profile.

In accordance with some embodiments of the present disclosure, an example method is provided. The example method comprises: providing a power factor correction converter comprising an input circuitry, an output circuitry, a boost circuitry, at least one switch, and a power factor correction converter controller, wherein the input circuitry is coupled to a power source, wherein the output circuitry is coupled to a load, wherein the boost circuitry is coupled to the input circuitry and the output circuitry, and wherein the boost circuitry comprises at least one capacitor, wherein the at least one switch is in the input circuitry or the boost circuitry; and operating the at least one switch to change states between an on state and an off state based on a first ratio, wherein operating in the on state causes the boost circuitry to charge the at least one capacitor and wherein operating in the off state causes the at least one capacitor to discharge, and wherein the first ratio is associated one or more time periods for the on state and one or more periods for the off state and also with a first efficiency threshold associated with the on state.

In some embodiments, the first efficiency threshold is associated with an optimal power factor efficiency.

In some embodiments the voltage input comprises a single-phase input voltage.

In some embodiments, the voltage input comprises a three-phase input voltage.

In some embodiments, the method further comprises determining, with the power factor correction converter controller, the first ratio based on a current load associated with the power factor correction converter.

In some embodiments, the method further comprises determining, with the power factor correction converter controller, the first ratio based on a load profile.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an exemplary PFC converter configured for a single-phase input voltage in accordance with one or more embodiments of the present disclosure;

FIG. 2 illustrates an example graph of efficiency versus AC power in accordance with one or more embodiments of the present disclosure;

FIG. 3 illustrates a flowchart of operations for a PFC converter in accordance with one or more embodiments of the present disclosure;

FIGS. 4A and 4B illustrate exemplary diagrams for a PFC converter configured for a single-phase input voltage in accordance with one or more embodiments of the present disclosure;

FIGS. 5A and 5B illustrate exemplary PFC converters configured for a three-phase input voltage in accordance with one or more embodiments of the present disclosure;

FIGS. 6A and 6B illustrate exemplary diagrams for a PFC converter configured for a three-phase input voltage in accordance with one or more embodiments of the present disclosure;

FIGS. 7A and 7B illustrate exemplary graphs for a PFC converter in accordance with one or more embodiments of the present disclosure;

FIGS. 8A and 8B illustrate exemplary graphs for a PFC converter in accordance with one or more embodiments of the present disclosure;

FIG. 9 illustrates an exemplary device in accordance with one or more embodiments of the present disclosure;

FIG. 10 illustrates an exemplary PFC converter configured with a two-channel PFC topology in accordance with one or more embodiments of the present disclosure;

FIG. 11 illustrates an example graph associated with a PFC converter configured with a two-channel topology and at least two modes in accordance with one or more embodiments of the present disclosure;

FIG. 12 illustrates exemplary graphs associated with a PFC converter configured with a two-channel topology in accordance with one or more embodiments of the present disclosure;

FIG. 13 illustrate exemplary graphs of currents associated with a PFC converter configured with a two-channel topology operating in a first mode in accordance with one or more embodiments of the present disclosure;

FIGS. 14A-14C illustrate exemplary graphs of currents associated with a PFC converter configured with a two-channel topology operating in a second mode in accordance with one or more embodiments of the present disclosure;

FIG. 15 illustrates an exemplary graph of currents associated with a PFC converter configured with a two-channel topology operating in a balanced mode in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to improved PFC converters.

Power factor correction may attempt to improve the true power used by a circuit and/or load. Power factor is the ratio of true power to apparent power. True power is the power used by a circuit and/or load. Apparent power is the power delivered to the circuit and/or load.

Conventional power factor correction converters are efficient in a narrow range or narrow band and inefficient outside of the narrow range or narrow band. For example, conventional PFC converters may be efficient at high loading and inefficient at low and/or medium loading. PFC converters, however, may be used in applications that power one or more loads at variable powers, including loadings where conventional PFC converters are inefficient. Operating in such inefficient ranges may cause a PFC converter to have multiple negative issues, including being inefficient, generating heat, generating noise, and the like. This may also include having a total harmonic distortion (THD) in the output current or in the circuitry of the PFC converter that may be associated with other of these negative issues.

The present disclosure includes multiple improvements, including providing a PFC converter that may operate at low, medium, and high loading with, among other things, improved efficiency, improved THD, improved power factor, improved heat performance (e.g., less heat generated), and/or improved noise generation (e.g., less noise). Additionally, the present disclosure may utilize certain components of the conventional PFC converters and, thus, keep costs low and allow for improved PFC converters without needing to expand device size and cost to accommodate additional electrical components.

Power factor correction for variable-load applications may be provided with a PFC converter generating an output voltage of a DC voltage from an input voltage. The input voltage may be, for example, an AC single phase voltage or an AC three-phase voltage. The PFC converter, by generating the output voltage, may be used to control one or more loads (e.g., motors), including variable-load. Such variable load applications may include but are not limited to providing power to variable speed loads (e.g., variable speed motors) and loadings with one or more loads being added or removed. Such applications may include air conditioning systems, home appliances, battery chargers, power supplies for residential, commercial, and/or industry applications, and the like.

The present disclosure is generally directed to improved PFC converters. The present disclosure includes, among other things, improved PFC converter controllers for operating PFC converters, including PFC converters with input voltages of single-phase AC input voltages and/or three-phase AC input voltages. The present disclosure also provides for, among other things, operating a PFC converter efficiently to provide DC power while at low and medium loading with the same or similar efficiency as at high loading.

Various embodiments of PFC converters of the present disclosure use one or more operations for charging and/or discharging of one or more capacitors in the PFC converter so that the DC power output provided may consistently provide power to loads while operating the PFC converter efficiently. Utilizing one or more switches, the PFC converter may be operated efficiently to charge these one or more capacitors. Then at low and/or medium loading the one or more switches may be operated to disconnect the capacitors from an input voltage to allow the capacitor to provide the DC power output. The closing or connecting and opening or disconnecting operations may be referred to as discontinuous operations as power is not being continuously provided. When at high loading applications, in contrast, the PFC converter may keep the one or more switches closed and operate continuously at a high level or point of efficiency. The PFC converter controller may operate to cycle the one or more switches to, among other things, operate the PFC converter at or nearly at a same level and/or point of efficiency as when continuously providing power to in a high load application. Such operations provide additional improvements described herein.

A PFC converter may be configured for continuous mode to provide power at a maximum load or in a high loading application. The PFC converter may operate at a high efficiency when highly loaded. Outside of the high loading the efficiency may degrade when at low or medium loading. The PFC converter may thus be configured with a high efficiency point, which may serve as a threshold, which may be referred to as a first efficiency threshold. In various embodiments, this first efficiency threshold may be within a range of the high efficiency point (e.g., +/−10% of power from the high efficiency point).

To operate the PFC converter at a loading associated with the first efficiency threshold, then a PFC converter controller may operate the PFC converter in one or more modes. For example, when operating at or above the first efficiency threshold the PFC converter may be operated according to a continuous mode where the PFC converter controller provides a continuous close signal to the one or more switches to provide for continuous conversion of an AC input voltage to DC output voltage. When operating below the first efficiency threshold the PFC converter may be operated in a low power mode where the PFC converter controller performs discontinuous operations where there is discontinuous conversion of an AC input voltage to DC output voltage. This discontinuous conversion may be due to connecting and disconnecting the AC input voltage from the DC output voltage for one or more periods of time by operating the one or more switches. Through the discontinuous operations the PFC converter controller may cause the AC input voltage to charge one or more capacitors and then disconnected the AC input voltage to cause the one or more capacitors to be discharged and to provide power to one or more loads. When the PFC converter controller operates the switches in a closed state, the PFC converter may be operated at or near the first efficiency threshold, and then when the switches are opened the PFC converter is not converting the AC input voltage into a DC voltage. Thus the discontinuous operations of the low power mode may allow for the PFC converter to operated efficiently while providing power to low and/or medium loads.

In the lower-power mode, the time periods for which the PFC converter closes the switches to an on state compared to the time periods for which the switches are open in an off state may be expressed as a ratio. This may be referred to as an on-off ratio or on-off duty cycle. While the switches are in the on state the PFC converter may be referred to as being on as the AC voltage is being converted to a DC voltage, and while the switches are open the PFC converter may be referred to as being in an off state as the AC voltage is not being converted to a DC voltage. However, in such an off state it will be appreciated that the PFC converter may still provide power to a load by discharging one or more capacitors.

In various embodiments, the time periods for which the PFC converter is in an on state as well as the time periods for which the PFC converter is in an off state are each time periods that are multiples of one period of a waveform of the AC input voltage. This may provide improved THD by avoiding switching at alternative periods that may create harmonics or stopping and/or starting input voltages mid-wave. The PFC converter controller may determine the timing for turning on and/or off the PFC converter by monitoring the loading applied and/or the charging and/or discharging of the one or more capacitors as well as by determining a prediction of loading in a future time period.

### Exemplary Apparatuses, Systems, and Methods

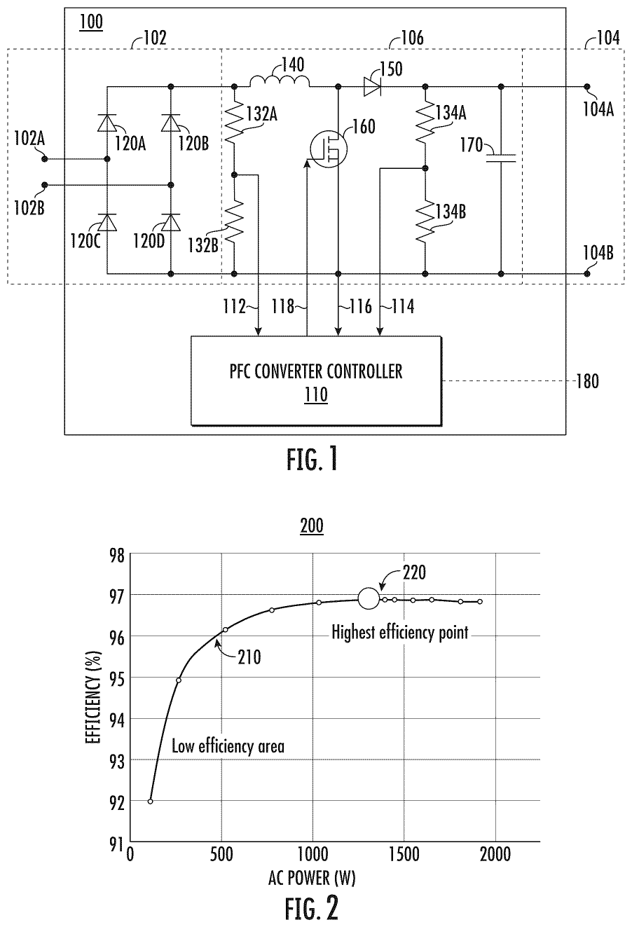

FIG. 1 illustrates an exemplary PFC converter configured for a single-phase input voltage in accordance with one or more embodiments of the present disclosure. The PFC converter 100 may include input circuitry 102, output circuitry 104, boost circuitry 106, and a PFC converter controller 110.

The input circuitry 102 may be configured to receive an input signal of a single-phase voltage, which may be at a first input terminal 102A and a second input terminal 102B. In various embodiments, the input circuitry may include a plurality of diodes 120 (e.g., 120A, 120B, 120C, 120D) that may be associated with rectification of the single-phase input.

The input circuitry 102 may be coupled to boost circuitry 106 that may be used to generate an output signal of a DC voltage to provide via the output circuitry 104. The output signal may be a DC voltage signal that may be provided to one or more loads, such as via a first output terminal 104A and a second output terminal 104B. In various embodiments, the input circuitry 102 and/or output circuitry 104 may include additional circuitry and/or electrical components, such as filters, switches, capacitors, and the like.

The boost circuitry 106 may include one or more inductors 140, one or more diodes 150, one or more switches 160, and one or more capacitors 170. In various embodiments, the one or more capacitors 170 may be referred to as bulk capacitors. The boost circuitry may be operated based on one or more signals from the PFC converter controller 110. For example, a switch 160 may be opened and/or closed based on a switch signal 118 generated by and provided by the PFC converter controller 110. The switch signal 118 may be a pulse width modulation (PWM) signal. Alternatively, it may be a binary signal that may instruct the switch to open and/or close.

The boost circuitry 106 may provide one or more signals to the PFC converter controller 110 that may, among other things, be a basis for generating the switch signal 118. For example, an AC voltage signal 112, an AC current signal 116, and/or a DC voltage signal 114 may be provided to the PFC converter controller 110. The AC voltage signal 112 may be taken from the boost circuitry 106 from a point between a first resistor 132A and a second resistor 132B that are coupled to the output of the input circuitry 102. The DC voltage signal 114 may be taken from the boost circuitry 106 from a point between a first resistor 134A and a second resistor 134B that are coupled to the output of the boost circuitry 106.

In various embodiments, the PFC converter controller 110 may receive and/or transmit one or more load signals 180 from an external source. For example, the one or more load signals 180 may be received and/or transmitted to a load controller. The one or more load signals may be associated with load information for generating and providing an output signal at terminals 104A, 104B.

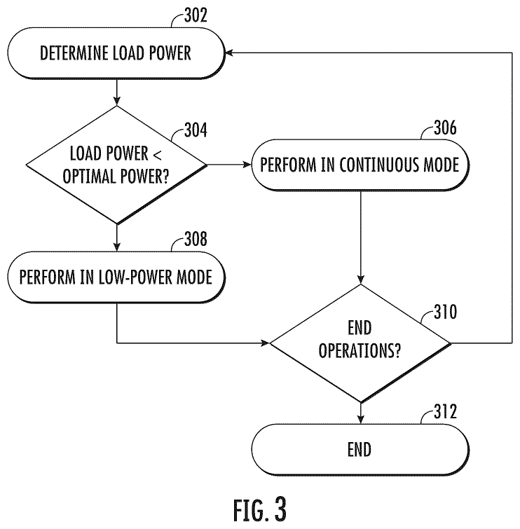

FIG. 2 illustrates an example graph of efficiency versus AC power in accordance with one or more embodiments of the present disclosure. The example graph 200 of efficiency illustrates the efficiency for various AC power. Various embodiments associated with the curve 210 of graph 200 may be configured to deliver up to 2000 W of AC power. The maximum efficiency for the PFC converter may be at a highest efficiency point 220, which may represent a first efficiency threshold.

For the graph 200, a low load or medium load may be associated with a lower AC power where the efficiency begins to fall off steeply, such as below 1000 W. For various embodiments associated with graph 200, loads being provided power above 1000 W may be operated with a continuous mode whereas loads requiring power below 1000 W may be operated with low power mode.

In various embodiments, the PFC converter is operated to maintain operations at or near the first efficiency threshold. When operating in the second mode of a low power mode with discontinuous operations, the PFC converter operates in an on state at this highest efficiency point 220 and then switches to an off state. In this manner, when the PFC converter 100 is in an on state it operates efficiently. When the PFC converter 100 is in an on state but the power load is lower than at this first efficiency threshold, then the PFC converter 100 may charge the capacitor 170 to store energy that may be discharged to the load(s) when the PFC converter is switched to an off state. The PFC converter 100 may then remain in an off state for a number of cycles of the AC waveform while the power stored in the capacitor 170 is discharged to the load(s). In the off state, the one or more diodes 150 prevent current flow from the discharging capacitor from flowing through the one or more diodes 150 and/or being provided to the rectified AC voltage.

When the PFC converter is operated at highest efficiency point 220 or in an associated range then the PFC converter will be operated at a power that is greater than what one or more loads require. In such operation a surplus energy will be stored in the one or more capacitors 170. This may increase the voltage of the one or more capacitors 170. In various embodiments, the surplus energy may be stored in the one or more capacitors until a capacitor high voltage threshold is reached. When at the capacitor high voltage threshold then the PFC converter 100 may be switch to an off state by switching the one or more switches 160 (e.g., from closed to open). Then the PFC converter controller 110 may keep the one or more switches 160 open for one or more periods of time to let the one or more capacitors 170 discharge and, thus, the loads to consumer the energy that was stored in the one or more capacitors 170. The PFC converter controller 110 may keep the one or more switches 160 in an open state until a capacitor lower voltage threshold is reached when the PFC converter controller 110 may operate the one or more switches 160 to close.

FIG. 3 illustrates a flowchart of operations for a PFC converter in accordance with one or more embodiments of the present disclosure. The operations of FIG. 3 may be performed by a PFC converter regardless of the input voltage it is configured to receive.

At operation 302, a load power may be determined. The PFC converter 100 may determine a load power for the one or more loads or it may receive a load power for the one or more loads.

At operation 304, determined if the load power is less than an optimal power. The optimal power may be associated with a first efficiency threshold, which may be the first efficiency threshold associated with the highest efficiency point 220. If the load power is greater than or equal to the optimal power, then the PFC converter 100 may perform operation 306. If the load power is less than the optimal power, then the PFC converter 100 may perform operation 308.

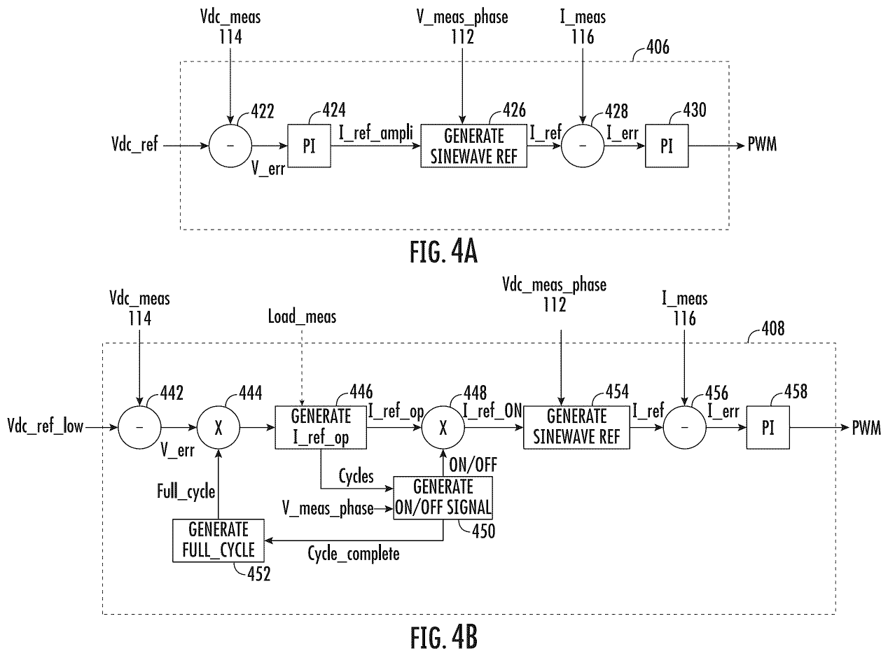

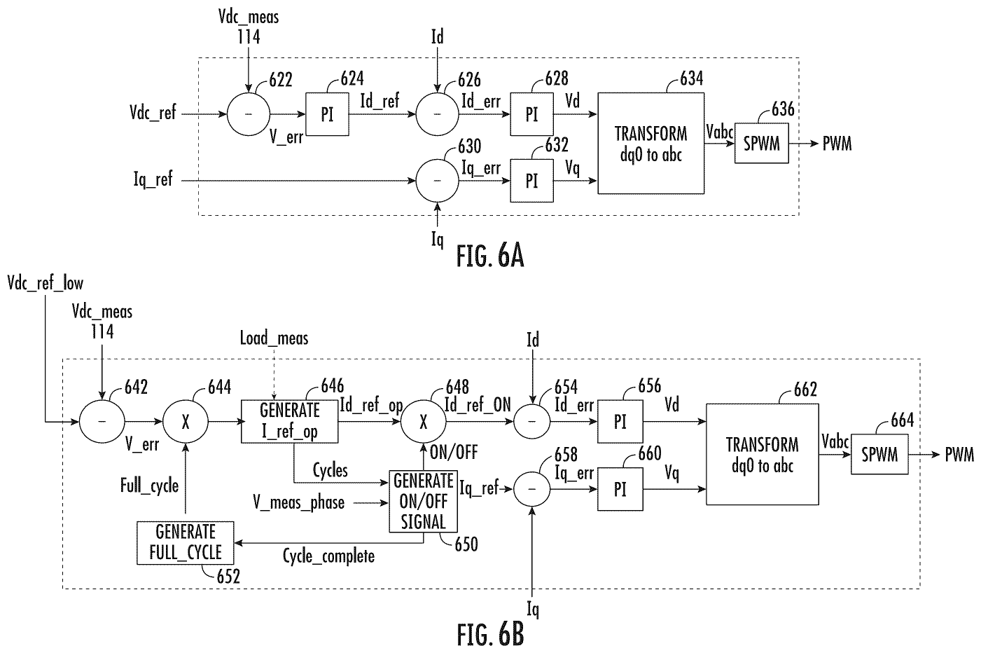

At operation 306, perform in continuous mode. The continuous operations mode is described further herein, including in association with at least FIG. 4A and with FIG. 6A.

At operation 308, perform in low power mode. The low power mode is described further herein, including in associated with FIG. 4B and with FIG. 6B.

At operation 310, determine if operations end. If the operations are not to end so that power is continued to be provided to one or more loads, then the PFC converter may proceed to operation 302 (or to continue with operations 306 or 308) to continue with or iterate one or more operations. If the operations are to end so that power is no longer to be provided to one or more loads, then the PFC converter may proceed to operation 312 to end operations.

At operation 312, end operations. If the PFC converter 100 is no longer to provide power to one or more loads, then the PFC converter 100 may end operations.

FIGS. 4A and 4B illustrate exemplary diagrams of operations for a PFC converter configured for a single-phase input voltage in accordance with one or more embodiments of the present disclosure. These figures illustrate operations performed by the PFC converter controller 110. The operations may be performed by hardware, software, or a mixture of hardware and software. Additional operations may be performed by the PFC converter controller, including but not limited to converting one or more signals from analog to digital (e.g., with an analog-to-digital converter (ADC)) and/or receiving one or more signals from outside the PFC converter controller 110.

FIG. 4A illustrates an exemplary diagram of operations for a PFC converter configured for a single-phase input voltage performing in a continuous mode in accordance with one or more embodiments of the present disclosure. During the continuous mode the PFC converter controller 110 may generate a PWM signal to be used as a switch signal 118 to control operation of the one or more switches 160.

At operation 422, a minus operation is performed to generate a V_err signal. The V_err signal is based on a measured Vdc_meas signal subtracted from a Vdc_ref signal. The Vdc_meas signal may be a DC voltage signal 114. The Vdc_ref signal may be set in or provided to the PFC converter controller 110.

At operation 424, a PI operation is performed on the V_err signal to generate an I_ref_ampli signal. The PI operation may be performed by a proportional and integral controller. The PI operation may generate the I_ref_ampli signal based on the V_err signal.

At operation 426, a sinewave ref generator may generate I_ref. The sinewave ref generator may generate I_ref based on the I_ref_ampli signal and a V_meas_phase signal received from one or more measurements from the boost circuitry 106, such as from AC voltage signal 112 that may allow for measuring the phase of the AC voltage signal 112. The I_ref signal may be based on the amplitude of the I_ref_ampli signal.

At operation 428, a minus operation is performed to generate an I_err signal. The I_err signal is based on a measured I_meas signal subtracted from the I_ref signal. The I_meas signal may be an AC current signal 116.

At operation 430, a PI operation is performed on the I_err signal to generate a PWM signal. The PWM signal may be a pulse width modulated (PWM) signal that is used to control the one or more switches 160 to change states from open to close.

FIG. 4B illustrates an exemplary diagram of operations for a PFC converter configured for a single-phase input voltage performing in a low power mode in accordance with one or more embodiments of the present disclosure. During the low power mode the PFC converter controller 110 may generate a PWM signal to be used as a switch signal 118 to control operation of the one or more switches 160.

At operation 442, a minus operation is performed to generate a V_err signal. The V_err signal is based on a measured Vdc_meas signal subtracted from a Vdc_ref_low signal. The Vdc_meas signal may be a DC voltage signal 114. The Vdc_ref_low signal may be set in the PFC converter controller 110 based on the highest efficiency point 220.

At operation 444, a multiplier operation may be performed on the V_err signal with a full_cycle signal. The full_cycle signal may be used to change the V_err signal to a zero so that operations do not further continue. Thus operation 444 may be used to communicate to operation 446 about a voltage bias at the end of a full cycle and, thus, operation 446 may generate I_ref_op to rebalance and/or balance the DC output voltage during a next cycle. For example, operation 444 may generate a signal provided to operation 446 that may allow for operation 446 to reduce or increase I_ref_op if V_err is, respectively, negative or positive. Various embodiments may omit this operation and the V_err signal may be pass to the operation 446.

At operation 446, and when a V_err signal is passed through operation 444, an I_ref_op generator may generate an I_ref_op signal. The I_ref_op signal is associated with a reference current associated with the optimal efficiency for the current and/or next cycle(s). In various embodiments the I_ref_op generator is configured to generate the I_ref_op signal based on the V_err signal received and also on a load_meas signal. The load_meas signal may be associated with a current, determined, and/or predicted load for the current and/or next cycle(s). Operation 446 may also generate a cycles signal associate with a number of cycles for which to turn on and/or turn off the switch 160. The cycles signal may be one or more values, such as a first value for a number of on cycles and a second value associated with off cycles.

In various embodiments, the PFC converter controller 110 may receive one or more load signals 180 as described herein. The one or more load signals 180 may include a load_meas signal. Thus the PFC converter controller 110 may receive or be informed by, for example, a load controller about one or more loads for one or more cycles. This may include, for example, the load controller may provide a load_meas signal associated with a required load during the next cycle. In such an example, the load controller may know or be programmed to accelerate a speed of a motor during the next cycle(s) and the load controller may transmit a load_meas signal to the PFC converter controller 110 about the DC output voltage to be generated to support such loading during the next cycle(s).

At operation 448, a multiplier operation may be performed on the I_ref_op signal and an ON/OFF signal. The ON/OFF signal may be associated with controlling the generation of a PWM signal for one or more cycles. For example, for a cycle where the switch 160 is turned on, the ON/OFF signal may be on or a value of 1. For a cycle where the switch 160 is to be turned off, the ON/OFF signal may be off or a value of 0. The multiplier operation may thus either pass zero or off signal or may pass an I_ref_ON signal to subsequent operations (e.g., operation 454).

At operation 450, the ON/OFF signal may be generated with an ON/OFF signal generator. The ON/OFF signal generator may receive a cycles signal and a V_meas_phase signal. The cycles signals may be received from operation 446 to indicate the number of on cycles and/or number of off cycles. The V_meas_phase signal (e.g., 112) may be used to measure and/or determine the phase of an AC input signal to track or determine when a cycle is complete. For example, it may be used to determine when a signal crosses zero going from negative to positive and/or positive to negative. The ON/OFF signal generator may generate an ON/OFF signal to provide a value of 1 for cycles when the PWM signal is to be generated to turn the switch 160 on and provide a value of 0 for cycles when the PWM signal is not to generated so that the switch 160 may be off. The ON/OFF signal generator may also generate a cycle-complete signal to provide to operation 452.

In various embodiments, the cycles signal may include a number of cycles to generate an ON signal for and a number of cycles to generate an off signal for. Alternatively, the cycles signal may include a number of cycles to be on for and then a total number of cycles until a subsequent ON signal should be generated for. The ON signal generator may act as, among things, a counter to determine the number of cycles that have occurred and, thus, when to generate an ON state and when to generate an OFF state for the ON/OFF signal.

In various embodiments, determining a full cycle is complete is determined based on a zero crossing associated with V_meas_phase signal (e.g., a phase measurement based on AC voltage signal 112). This may allow for operations to be started and/or stopped based on multiples of full cycles, which may be based on a time period associated with a cycle and multiples thereof.

At operation 452, may generate the full_cycle signal to provide to operation 444 based on the cycle_complete signal. The cycle_complete signal may, for example, be a pulse whenever a cycle is complete, which may cause the full_cycle signal to change state in accord with operations described herein.

At operation 454, a sinewave ref generator may generate I_ref. The sinewave ref generator may generate I_ref based on the I_ref_ON signal and a V_meas_phase signal received from one or more measurements from the boost circuitry 106, such as from AC voltage signal 112 that may allow for measuring the phase of the AC voltage signal 112. The I_ref signal may be based on the amplitude of the I_ref_ON signal.

At operation 456, a minus operation is performed to generate an I_err signal. The I_err signal is based on a measured I_meas signal subtracted from the I_ref signal. The I_meas signal may be signal associated with a current measurement (e.g., AC current signal 116). For example, in various embodiments the I_meas signal measures the AC current, such as with a shunt resistor or other isolated sensor.

At operation 458, a PI operation is performed on the I_err signal to generate a PWM signal. The PWM signal may be a pulse width modulated (PWM) signal that is used to control the one or more switches 160 to change states from open to close.

In various embodiments, the PFC converter 100 may determine the current and/or future charge of the capacitor 170 and based on the determination adjust operations in a lower-power mode.

For example, the PFC converter controller 110 may receive one or more signals (e.g., 112, 114, 116) and determine the charge on the capacitor and predict the charge of the capacitor over the remaining time period(s) of a charging-discharging cycle. This way the PFC converter controller 110 may determine when the capacitor is fully charged and when the capacitor is fully discharged.

The PFC converter controller 110 may then control and/or adjust operations so that the capacitor 170 will have charge to provide energy to one or more loads. The PFC converter controller 110 may restart charging before the capacitor 170 is fully discharged so that a load is continuously provided power, which may include adjusting a current operation. Alternatively or additionally, in various embodiments the PFC controller 110 may allow for fully the capacitor 170 to be fully discharged. In various embodiments, fully discharged may also refer to one or more parameters set in the PFC converter controller (e.g., Vdc_ref_min) that may keep operations in a safe and/or boost mode. Additionally, or alternatively, the PFC converter controller may stop operating the converter (e.g., via an OFF signal or a forced OFF signal) if the capacitor 170 is fully charged. This may keep the capacitor 170 from being overcharged. In various embodiments, fully charged may also refer to one or more parameters set in the PFC converter controller (e.g., Vdc_ref_max) that may keep operations in a safe mode of operations and/or at a convenient level of output.

In various embodiments, the PFC converter controller 110 may predict, forecast, model, and/or determine the power required by the load for the current charging-discharging cycle and one or more subsequent charging-discharging cycles, including one or more time periods associated with a waveform in the current and subsequent charging-discharging cycles. This may be based on the recent load experience, load control, and/or one or more signals received regarding future load control.

In various embodiments, the prediction, forecast, modelling, and/or determination may be based on one or more profiles (e.g., device profiles, load profiles, etc.) programmed and/or stored into the PFC converter controller 110 or received from an external source. For example, a PFC converter controller 110 may be configured with known load and/or loading profiles.

In various embodiments, the PFC converter controller 110 may determine an amount of surplus energy in a capacitor 170 after each waveform cycle during a charging-discharging cycle. This may allow for the PFC converter controller 110 to determine that there is sufficient surplus energy in the capacitor 170 to power the load(s) during discharging of the capacitor. In various embodiments, there may be a minimum charge threshold for the capacitor 170 that the PFC converter controller 110 may not allow the capacitor 170 to fall below. Additionally or alternatively, there may be a maximum charge threshold for the capacitor 170 that the PFC converter controller 110 may not charge the capacitor 170 above. The minimum charge threshold and/or maximum charge threshold may be set based on a safety margin associated with the capacitor 170, where the safety margin is a percentage or value of charge associated with the minimum and/or maximum charge the capacitor 170 may be capable of holding. To prevent the minimum charge threshold and/or the maximum charge threshold from being passed the PFC converter controller 110 may adjust the number of waveform cycles and/or the on-off ratio to control the charge of the capacitor 170. Alternatively or additionally, the charging-discharging cycles may be based on hitting a minimum charge threshold and/or a maximum charge threshold, which may start the next charging-discharging cycle and/or adjust the current charging/discharging cycle.

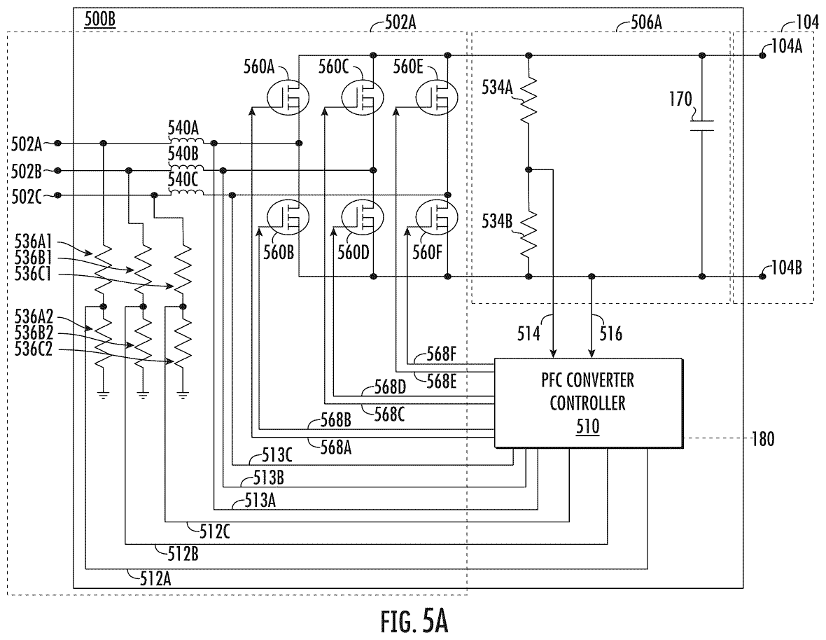

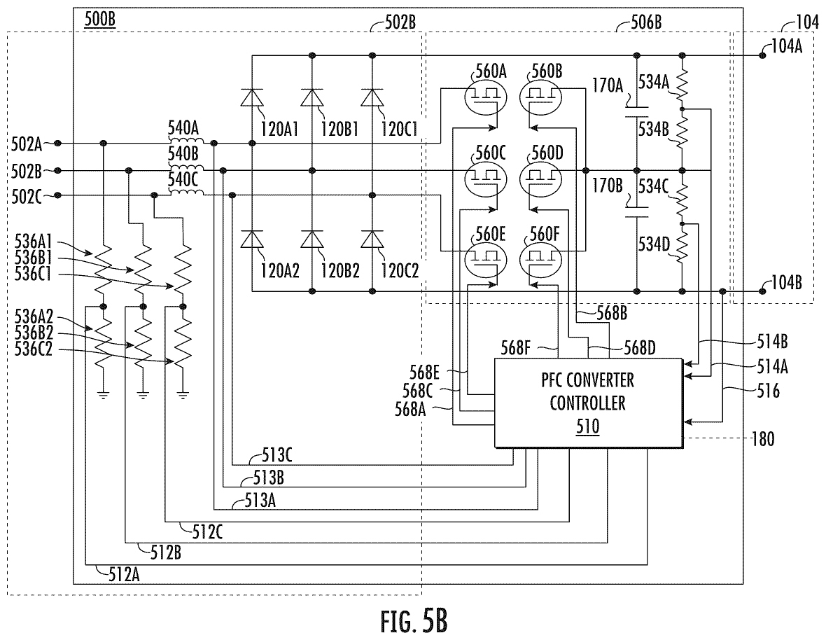

FIG. 5A illustrates an exemplary PFC converter configured for a three-phase input voltage in accordance with one or more embodiments of the present disclosure. The PFC converter 500A may include input circuitry 502A, output circuitry 104, boost circuitry 506A, and a PFC converter controller 510. The output circuitry 104 may be similar, or may be different, from a PFC converter 100 that is configured for a single-phase voltage input. In various embodiments, the input circuitry 502A, output circuitry 104, and/or the boost circuitry 506A may include additional or omit circuitry and/or electrical components, such as filters, switches, capacitors, inductors, and the like.

It will be appreciated that the exemplary PFC converter of FIG. 5A illustrates one example and/or one topology of a three-phase PFC converter. It will be further appreciated that the present disclosure is not limited to the illustrated topology. For example, the present disclosure may also apply to other three-phase PFC converter topologies, such as those illustrated in FIG. 5B and/or offered by STMicroelectronics with its Vienna topology.

The input circuitry 502A may be coupled to boost circuitry 506A that may be used to generate an output signal to provide via the output circuitry 104. The input circuitry 502A may include a plurality of inductors 540 (e.g., 540A, 540B, 540C) and a plurality of switches 560 (e.g., transistors 560A, 560B, 560C, 560D, 560E, 560F) that may be operated by the PFC converter controller 510 to control the three input phases 502 (e.g., 502A, 502B, 502C). In various embodiments each of the three phases may be associated with one or more inductors 540. For example, a first phase received at input terminal 502A may be associated with a first inductor 540A, a second phase received at input terminal 502B may be associated with a second inductor 540B, and a third phase received at input terminal 502C may be associated with a third inductor 540C. Each of the plurality of switches 560 may be operated by an associated control signal 568 (e.g., 568A, 568B, 568C, 568D, 568E, 568F). The operation of the plurality of switches 560 may be operated to open and close the switches. The plurality of switches 560 may be operated to provide an AC signal to the boost circuitry 506A of the PFC converter 500, such as to charge capacitor 170. Additionally or alternatively, in various embodiments the input circuitry 502A may also include one or more drivers associated with eh control signal(s) 568, which may be used to drive a respective switch based on a control signal 568 from the PFC controller 510. Alternatively or additionally, various embodiments of the input circuitry 502 may include a plurality of diodes, such as a diode instead of each of the switches 560 illustrated, which may provide for control of providing an AC voltage signal to the boost circuitry 106. The input circuitry 502 may also include additional circuitry and/or electrical components, such as diodes, switches, capacitors, inductors, and the like.

In various embodiments, the input circuitry 502A may include AC voltage sensing circuitry and/or AC current sensing circuitry.

The AC voltage sensing circuitry may include a plurality of resistors 536 (e.g., 536A1, 536A2, 536B1, 536B2, 536C1, 536C2) that may be used to acquire an AC voltage signal for each of the phases that is provided to the PFC converter controller 510.

For example, an AC voltage signal associated with the A phase 512A of a three-phase input may include a resistor 536A1 coupled to resistor 536A2 coupled to ground as illustrated. The AC voltage signal associated with the A phase 512A may be taken from between resistor 536A1 and resistor 536B1 and provided to the PFC converter controller 510. Similarly, an AC voltage signal associated with the B phase 512B and resistors 536B1 and 536B2 and an AC voltage signal associated with the C phase 512C and resistors 536C1 and 536C2 may be acquired and provided to the PFC converter controller 510. The AC voltage sensing circuitry may also include additional circuitry and/or electrical components, such as analog-to-digital converters and the like.

In various embodiments additionally circuitry may be used to determine the AC voltage signal for each of the A, B, and C phases, such as by acquiring the voltage based on the point between the respective resistors as illustrated and also from a point between a respective resistor and the ground. These voltage may be used to generate the AC voltage signal for a respective phase and provide that to the PFC converter controller 510.

The AC current sensing circuitry may include acquiring one or more AC current signals 513 from the three phase inputs 502 and after the inductors 540. An AC current signal associated with the A phase 513A may be provided to the PFC converter controller 510. Similarly, an AC current signal associated with the B phase 513B and an AC current signal associated with the C phase 513C may be provided to the PFC converter controller 510. The AC current sensing circuitry may also include additional circuitry and/or electrical components, such as analog-to-digital converters and the like.

The boost circuitry 506A may include one or more resistors (e.g., 534) and one or more capacitors 170. In various embodiments, the one or more capacitors 170 may be referred to as bulk capacitors. The input circuitry 502A and the boost circuitry 506A may be operated based on one or more signals from the PFC converter controller 510. For example, one or more switches 560 may be opened and/or closed based on one or more switch signals 568 generated by and provided by the PFC converter controller 510. The switch signal(s) 568 may be PWM signal(s). Alternatively, it may be a binary signal that may instruct the switch to open and/or close.

The boost circuitry 506A may provide one or more signals to the PFC converter controller 510 that may, among other things, be a basis for generating the switch signal(s) 568. For example, a DC voltage signal 514 and a DC current signal 516 may be provided to the PFC converter controller 510. The DC voltage signal 514 may be taken from a point between a first resistor 534A and a second resistor 534B that are coupled to the output of the boost circuitry 506A.

FIG. 5B illustrates an exemplary PFC converter configured for a three-phase input voltage in accordance with one or more embodiments of the present disclosure. The PFC converter 500B may include input circuitry 502B, output circuitry 104, boost circuitry 506B, and a PFC converter controller 510. The output circuitry 104 may be similar, or may be different, from a PFC converter 100 that is configured for a single-phase voltage input. In various embodiments, the input circuitry 502B, output circuitry 104, and/or the boost circuitry 506B may include additional or omit circuitry and/or electrical components, such as filters, switches, capacitors, inductors, and the like.

The input circuitry 502B may be coupled to boost circuitry 506B that may be used to generate an output signal to provide via the output circuitry 104. The input circuitry 502B may include a plurality of inductors 540 (e.g., 540A, 540B, 540C) and a plurality of diodes 120 (e.g., diodes 120A1, 120A2, 120B1, 120B2, 120C1, 120C2). In various embodiments each of the three phases may be associated with one or more inductors 540. For example, a first phase received at input terminal 502A may be associated with a first inductor 540A, a second phase received at input terminal 502B may be associated with a second inductor 540B, and a third phase received at input terminal 502C may be associated with a third inductor 540C. The input circuitry 502B may also include additional circuitry and/or electrical components, such as diodes, switches, capacitors, inductors, and the like.

In various embodiments, the input circuitry 502A may include AC voltage sensing circuitry and/or AC current sensing circuitry.

The AC voltage sensing circuitry may include a plurality of resistors 536 (e.g., 536A1, 536A2, 536B1, 536B2, 536C1, 536C2) that may be used to acquire an AC voltage signal for each of the phases that is provided to the PFC converter controller 510.

For example, an AC voltage signal associated with the A phase 512A of a three-phase input may include a resistor 536A1 coupled to resistor 536A2 coupled to ground as illustrated. The AC voltage signal associated with the A phase 512A may be taken from between resistor 536A1 and resistor 536B1 and provided to the PFC converter controller 510. Similarly, an AC voltage signal associated with the B phase 512B and resistors 536B1 and 536B2 and an AC voltage signal associated with the C phase 512C and resistors 536C1 and 536C2 may be acquired and provided to the PFC converter controller 510. The AC voltage sensing circuitry may also include additional circuitry and/or electrical components, such as analog-to-digital converters and the like.

In various embodiments additionally circuitry may be used to determine the AC voltage signal for each of the A, B, and C phases, such as by acquiring the voltage based on the point between the respective resistors as illustrated and also from a point between a respective resistor and the ground. These voltage may be used to generate the AC voltage signal for a respective phase and provide that to the PFC converter controller 510.

The AC current sensing circuitry may include acquiring one or more AC current signals 513 from the three phase inputs 502 and after the inductors 540. An AC current signal associated with the A phase 513A may be provided to the PFC converter controller 510. Similarly, an AC current signal associated with the B phase 513B and an AC current signal associated with the C phase 513C may be provided to the PFC converter controller 510. The AC current sensing circuitry may also include additional circuitry and/or electrical components, such as analog-to-digital converters and the like.

The boost circuitry 506B may include one or more resistors 534 (e.g., 534A, 534B, 534C, 534D), one or more capacitors 170 (e.g., 170A, 170B), and a plurality of switches 560 (e.g., transistors 560A, 560B, 560C, 560D, 560E, 560F) that may be operated by the PFC converter controller 510 to control the three input phases 502 (e.g., 502A, 502B, 502C) charging and discharging of the one or more capacitors 170. In various embodiments, the one or more capacitors 170 may be referred to as bulk capacitors. The input circuitry 502B and the boost circuitry 506B may be operated based on one or more signals from the PFC converter controller 510. For example, one or more switches 560 may be opened and/or closed based on one or more switch signals 568 generated by and provided by the PFC converter controller 510. The switch signal(s) 568 may be PWM signal(s). Alternatively, it may be a binary signal that may instruct the switch to open and/or close.

Each of the plurality of switches 560 (e.g., 560A, 560B, 560C, 560D, 560E, 560F) may be operated by an associated control signal 568 (e.g., 568A, 568B, 568C, 568D, 568E, 568F). The operation of the plurality of switches 560 may be operated to open and close the switches. The plurality of switches 560 may be operated to provide an AC signal to the boost circuitry 506B of the PFC converter 500B, such as to charge capacitors 170 (e.g., 570A, 570B). Additionally or alternatively, in various embodiments the boost circuitry 506B may also include one or more drivers associated with eh control signal(s) 568, which may be used to drive a respective switch based on a control signal 568 from the PFC controller 510.

The boost circuitry 506BA may provide one or more signals to the PFC converter controller 510 that may, among other things, be a basis for generating the switch signal(s) 568. For example, one or more DC voltage signals 514 (e.g., 514A, 514B) and a DC current signal 516 may be provided to the PFC converter controller 510. A first DC voltage signal 514A may be taken from a point between resistor 534A and resistor 534B. A second DC voltage signal 514B may be taken from a point between a resistor 534C and resistor 534D. In various embodiments additionally circuitry may be used to determine the DC voltage signals 514A, 514B, such as by acquiring the voltage based on the point between the respective resistors as illustrated and also from a point one each side of a respective resistor (e.g., 534B or 534D). Each of these respective voltages from two points may be used to generate the DC voltage signal across a resistor (e.g., 534B or 534D) and provided that to the PFC converter controller 510. This DC voltage sensing circuitry may also include additional circuitry and/or electrical components, such as analog-to-digital converters and the like.

In various embodiments, the first efficiency threshold associated with the highest efficiency point 220 may change with temperature. The PFC converter controller (e.g., 110, 510) may provide, determine, adjust, or optimize the Vdc_ref signal and/or Vdc_ref_low signal based on a temperature. The temperature may be measured by, for example, a temperature sensor in the PFC converter (e.g., 100, 500).

In various embodiments, the first efficiency threshold associated with the highest efficiency point 220 may change based on the DC voltage required by one or more loads. In various embodiments the PFC converter (e.g., 100, 500) may have losses (e.g., switching losses) that may cause variations or reduction in the DC voltage. The PFC converter controller (e.g., 110, 510) may receive, determine, adjust, or optimize the Vdc_ref signal and/or Vdc_ref_low signal based on the DC voltage (e.g., DC voltage signal 114, DC voltage signal 512).

In various embodiments, the on-off ratio in one or more switch signals (e.g., 118, 568) may be adjusted and/or changed to avoid and/or remove one or more unwanted harmonics. The PFC converter (e.g., 100, 500) may determine if one or more harmonics are present or predict based on past and current operations that one or more harmonics are likely to be generated based on past and current operations. The PFC converter (e.g., 100, 500) may adjust the on-off ratio by adjusting the number of ON cycles and/or the number of OFF cycles in a charging-discharging cycle, which may remove or prevent harmonics. Alternatively or additionally, the PFC converter (e.g., 100, 500) may utilize on or more randomized charging-discharging cycles with a randomized on-off ratio to prevent harmonics from being generated.

FIGS. 6A and 6B illustrate exemplary diagrams for a PFC converter configured for a three-phase input voltage in accordance with one or more embodiments of the present disclosure. These figures illustrate operations performed by the PFC converter controller 510. The operations may be performed by hardware, software, or a mixture of hardware and software. Additional operations may be performed by the PFC converter controller 510, including but not limited to converting one or more signals from analog to digital (e.g., with an analog-to-digital converter (ADC)), receiving one or more signals from outside the PFC converter controller 510, and/or performing one or more transforms on a signal. For example, the PFC converter 500 may have an DC current signal 516 that may be provided to ADC and/or a transformer to transform the current with a direct-quadrature (DQ) transform (e.g., Park Transform, Clarke Transform). The DC current signal 516, after the DQ transform, may be transformed into an Id and Iq, which may be used in one or more operations described herein.

In various embodiments, the exemplary diagrams of FIGS. 6A and 6B may be used to generate one or more switch signals 568. Various embodiments may include a PFC converter controller 510 that may generate each of the one or more switch signals 568 with separate operations illustrated in FIG. 6A and/or 6B for each of the one or more switch signals 568 (e.g., utilizing 6 separate PWM channels to generate 6 PWM signals). Alternatively or additionally, various embodiments may include a PFC converter controller 510 that may generate one or more of the switch signals 568 according to the operations illustrated in FIG. 6A and/or 6B by performing one or more shared operations that are used to generate the one or more switch signals 568 (e.g., utilizing 1 PWM channel to generate 6 PWM signals).

FIG. 6A illustrates an exemplary diagram of operations for a PFC converter configured for a three-phase input voltage performing in a continuous mode in accordance with one or more embodiments of the present disclosure. During the continuous mode the PFC converter controller 510 may generate one or more PWM signals to be used as one or more switch signals 568 to control operation of the one or more switches 560.

At operation 622, a minus operation is performed to generate a V_err signal. The V_err signal is based on a measured Vdc_meas signal subtracted from a Vdc_ref signal. The Vdc_meas signal may be a DC voltage signal 514. The Vdc_ref signal may be set in or provided to the PFC converter controller 510.

At operation 624, a PI operation is performed on the V_err signal to generate an Id_ref signal. The PI operation may be performed by a proportional and integral controller. The PI operation may generate the Id_ref signal based on the V_err signal.

At operation 626, a minus operation is performed to generate an Id_err signal. The Id_err signal is based on an Id signal associated with a current measurement (e.g., DC current signal 516) subtracted from an Id_err signal.

At operation 628, a PI operation is performed on the Id_err signal to generate a Vd signal. The PI operation may be performed by a proportional and integral controller. The PI operation may generate the Vd signal based on the Id_err signal. The Vd signal may be associated with a voltage in the DQ domain.

At operation 630, a minus operation is performed to generate an Iq_err signal. The Iq_err signal is based on an Iq signal associated with a current measurement (e.g., DC current signal 516) subtracted from an Iq_ref signal. The Iq_ref signal may be set in or provided to the PFC converter controller 510.

At operation 632, a PI operation is performed on the Iq_err signal to generate a Vq signal. The PI operation may be performed by a proportional and integral controller. The PI operation may generate the Vq signal based on the Iq_err signal. The Vq signal may be associated with a voltage in the DQ domain.

At operation 634, a transform from dq0 to abc is performed. The transform of operation 634 may transform the vector voltages of the Vd signal and the Vq signal into the abc domain. This may be referred to as a reverse transform (e.g., reverse Park transform, reverse Clarke transform) as it may be associated with reversing one or more prior transforms that generated vectors in the DQ domain.

At operation 636, a SPWM operation is performed on the Vabc signal to generate one or more PWM signals. The PWM signal(s) may be a pulse width modulated (PWM) signal that is used to control the one or more switches 560 to change states from open to close.

FIG. 6B illustrates an exemplary diagram of operations for a PFC converter configured for a three-phase input voltage performing in a low power mode in accordance with one or more embodiments of the present disclosure. During the lower-power mode the PFC converter controller 510 may generate one or more PWM signals to be used as a switch signals 568 to control operation of the one or more switches 560.

At operation 642, a minus operation is performed to generate a V_err signal. The V_err signal is based on a measured Vdc_meas signal subtracted from a Vdc_ref_low signal. The Vdc_meas signal may be a DC voltage signal 514. The Vdc_ref_low signal may be set in or received by the PFC converter controller 510 based on a highest efficiency point 220.

At operation 644, a multiplier operation may be performed on the V_err signal with a full_cycle signal. Thus operation 644 may be used to communicate to operation 646 about a voltage bias at the end of a full cycle and, thus, operation 646 may generate I_ref_op to rebalance and/or balance the DC output voltage during a next cycle. For example, operation 644 may generate a signal provided to operation 646 that may allow for operation 646 to reduce or increase I_ref_op if V_err is, respectively, negative or positive. Various embodiments may omit this operation and the V_err signal may be passed to operation 646.

At operation 646, and when a V_err signal is passed through operation 644, an Id_ref_op generator may generate an Id_ref_op signal. The Id_ref_op signal is associated with a reference current associated with the optimal efficiency for the current and/or next cycle(s). In various embodiments the Id_ref_op generator is configured to generate the Id_ref_op signal based on the V_err signal received and also on a load_meas signal. The load_meas signal may be associated with a current, determined, and/or predicted load for the current and/or next cycle(s). Operation 646 may also generate a cycles signal associate with a number of cycles for which to turn on and/or turn off the switches 560. The cycles signal may be one or more values, such as a first value for a number of on cycles and a second value associated with off cycles.

At operation 648, a multiplier operation may be performed on the Id_ref_op signal and an ON/OFF signal. The ON/OFF signal may be associated with controlling the generation of a PWM signal for one or more cycles. For example, for a cycle where a switch 560 is turned on, the ON/OFF signal may be on or a value of 1. For a cycle where a switch 560 is to be turned off, the ON/OFF signal may be off or a value of 0. The multiplier operation may thus either pass zero or off signal or may pass an Id_ref_ON signal to subsequent operations (e.g., operation 654).

At operation 650, the ON/OFF signal may be generated with an ON/OFF signal generator. The ON/OFF signal generator may receive a cycles signal and a V_meas_phase signal. The cycles signals may be received from operation 646 to indicate the number of on cycles and/or number of off cycles. The V_meas_phase signal (e.g., 512) may be used to measure and/or determine the phase of an AC input signal to track or determine when a cycle is complete. For example, it may be used to determine when a signal crosses zero going from negative to positive. The ON/OFF signal generator may generate an ON/OFF signal to provide a value of 1 for cycles when the PWM signal is to be generated to turn a switch 560 on and provide a value of 0 for cycles when the PWM signal is not to generated so that a switch 560 may be off. The ON/OFF signal generator may also generate a cycle-complete signal to provide to operation 652.

In various embodiments, the cycles signal may include a number of cycles to generate an ON signal for and a number of cycles to generate an off signal for. Alternatively, the cycles signal may include a number of cycles to be on for and then a total number of cycles until a subsequent ON signal should be generated for. The ON signal generator may act as, among things, a counter to determine the number of cycles that have occurred and, thus, when to generate an ON state and when to generate an OFF state for the ON/OFF signal.

In various embodiments, determining a full cycle is complete is determined based on a zero crossing associated with V_meas_phase signal (e.g., a phase measurement based on 512). This may allow for operations to be started and/or stopped based on multiples of full cycles, which may be based on a time period associated with a cycle and multiples thereof.

At operation 652, may generate the full_cycle signal to provide to operation 644 based on the cycle_complete signal. The cycle_complete signal may, for example, be a pulse whenever a cycle is complete, which may cause the full_cycle signal to change state in accord with operations described herein.

At operation 654, a minus operation is performed to generate an Id_err signal. The Id_err signal is based on an Id signal associated with a current measurement (e.g., DC current signal 516) subtracted from an Id_ref_ON signal.

At operation 656, a PI operation is performed on the Id_err signal to generate a Vd signal. The PI operation may be performed by a proportional and integral controller. The PI operation may generate the Vd signal based on the Id_err signal. The Vd signal may be associated with a voltage in the DQ domain.

At operation 658, a minus operation is performed to generate an Iq_err signal. The Iq_err signal is based on an Iq signal associated with a current measurement (e.g., DC current signal 516) subtracted from an Iq_ref signal. In various embodiments the Iq_ref signal, which may be associated with reactive power, may be set to 0. The Iq_ref signal may be set in or provided to the PFC converter controller 510.

At operation 660, a PI operation is performed on the Iq_err signal to generate a Vq signal. The PI operation may be performed by a proportional and integral controller. The PI operation may generate the Vq signal based on the Iq_err signal. The Vq signal may be associated with a voltage in the DQ domain.

At operation 662, a transform from dq0 to abc is performed. The transform of operation 634 may transform the vector voltages of the Vd signal and the Vq signal into the abc domain. This may be referred to as a reverse transform (e.g., reverse Park transform, reverse Clarke transform) as it may be associated with reversing one or more prior transforms that generated vectors in the DQ domain.

At operation 664, a SPWM operation is performed on the Vabc signal to generate one or more PWM signals. The PWM signal(s) may be a pulse width modulated (PWM) signal that is used to control the one or more switches 560 to change states from open to close.

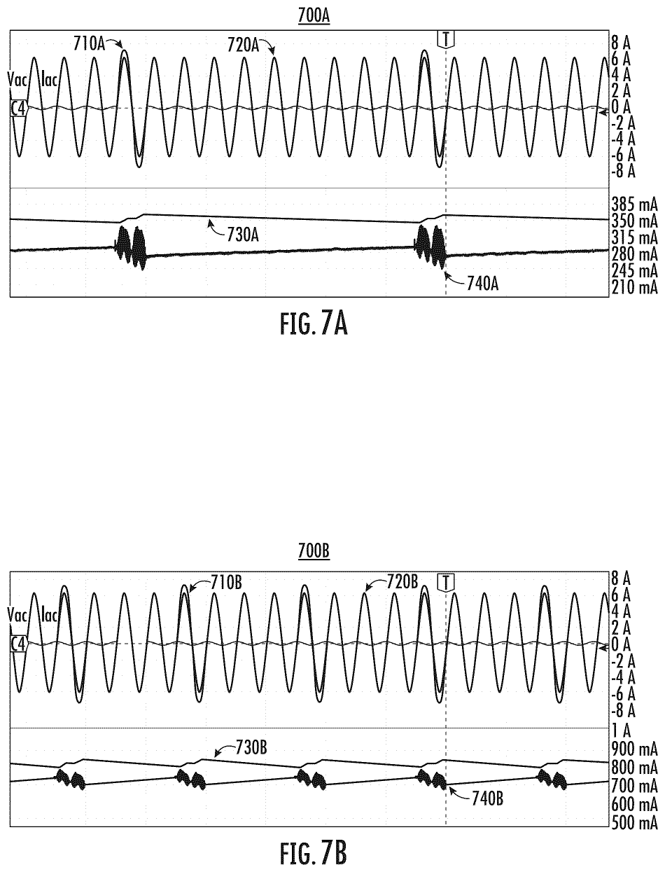

FIGS. 7A and 7B illustrate exemplary graphs for a PFC converter in accordance with one or more embodiments of the present disclosure.

FIG. 7A illustrates a first exemplary graph for a PFC converter in accordance with one or more embodiments of the present disclosure. This first graph illustrates four curves: a Vac_in_meas curve 710A, an Iac_meas curve 720A, a Iac_meas curve 730A, and an Idc_out_meas curve 740A.

The Vac_in_meas curve 710A is an example of a measurement of a single-phase input voltage, such as at the input circuitry 102. The Iac_meas curve 720A is an example of a measurement of an AC current, such as measured at AC current signal 116. The Vdc_out_meas curve 730A is an example of a measurement of a DC output voltage, such as measured between a first output terminal 104A and a second output terminal 104B. The Idc_out_meas curve 740A is an example of a measurement of a DC output voltage, such as measured between a first output terminal 104A and a second output terminal 104B.

As illustrated in FIG. 7A, the Iac_meas curve 720A may be for a time period of single cycle of a time period of 10 waves. As described herein, the Iac_meas curve 720A on for one cycle may be associated with a switch 160 in an on state, such as during operation during a lower power mode (e.g., 308). As illustrated, the on state of FIG. 7A may be a ratio of 1:9 of one cycle on to nine cycles off. Alternatively, the ratio may be described as 1:10 of one cycle on of a time period of 10 cycles. While the Iac_meas curve 720A is on, the capacitor 170 is charged during the same time period(s) and/or cycle(s). As illustrated with the Iac_meas curve 730A and Idc_out_meas curve 740A, the capacitor discharges and provides a current and/or voltage to one or more loads.

In various embodiments illustrates in FIG. 7A, an exemplary load may be 100 W and the PFC converter 100 may be operated at a first efficiency threshold associated with the highest efficiency point 220 of 1,000 W. Compared to the 1,000 W, the 100 W is a low loading. To operate efficiently the PFC convert 100 may be operated at 1,000 W for one cycle to converter 1,000 W of power from an AC input at the input circuitry 102. Of the 1,000 W of DC power, 100 W may be used by one or more loads coupled to the output circuitry 104 in the first cycle and then the other 900 W of energy may be used by the one or more loads over the following 9 cycles. The surplus 900 W of energy in the first cycle may be stored by charging the one or more capacitors 170. The one or more capacitors 170 may then be discharged over the following 9 cycles to provide power to the one or more loads. Thus the PFC converter 100 may be operated at an on-to-off ratio of 1:9, which also corresponds to an on-to-time period of 1:10 or a 10% duty cycle for the PFC converter 100.

In various embodiments, the on-off ratio may be for a total number of cycles associated with a power to fully charge and discharge the capacitor. As described herein, an example may be an on-off ratio of 1:9 with a power of 1,000 W generated during the single on state for one waveform cycle and accumulating energy of 900 W so that the 9 waveform cycles of discharging at 100 W per waveform cycle discharges the energy accumulated in the capacitor 170 so the capacitor 170 may be discharged at the end of the 9 waveform cycles when the switch 160 is in an off state. A charging-discharging cycle illustrated in FIG. 7A lasts 10 waveform cycles.

In various embodiments, the on-off ratio may be associated with a power that is not a multiple of the load such that after one charging-discharging cycle there is still power accumulated in the capacitor 170 before the next charging-discharging cycle would begin.

As illustrated in FIG. 7A, the Vac_in_meas curve 710A may have a time period of 10 cycles for switching on and off a switch 160. FIG. 7A illustrates that in the 9 periods that the switch 160 may be off there may be a voltage of that is not a flat curve of zero volts for an associated Vdc voltage (e.g., 730A). This may be due to, for example, a reactive current flowing that may be associated with the voltage illustrated during these 9 off cycles. An example of circuitry that may be associated with the reactive current(s) is a capacitive filter or the like. In various embodiments, the voltage may instead be zero during such off cycles. Additionally or alternatively, during one or more off cycles, the PFC converter controller 110 may set, provide, or generate an offset reference current that may cancel out or mitigate one or more currents present during the off cycles as illustrated in FIG. 7A. Such an offset reference current may cancel out the oscillation illustrated in the voltage of the Vac_in_meas curve 710A during off cycles.

As illustrated in FIG. 7A, the Idc_out_meas curve 740A may include one or more high frequency oscillations of the load current. For example, the on cycle illustrated in the Idc_out_meas curve 740A includes high frequency oscillators and, thus, is not clean flat curve or line. In various embodiments, such high frequency oscillations may be due to electronic load behavior. For example, this may be due to the load being a constant power load. In various embodiments, the Idc_out_meas curve 740A may, for on cycles, be a curve without high frequency oscillations. Thus the output at output terminals 104A, 104B may be provided to one or more loads without high frequency oscillations or with high frequency oscillations being compensated for in the PFC converter controller 110.

FIG. 7B illustrates a second exemplary graph for a PFC converter in accordance with one or more embodiments of the present disclosure. This second graph illustrates four curves: a Vac_in_meas curve 710B, an Iac_meas curve 720B, a Vdc_out_meas curve 730B, and an Idc_out_meas curve 740B.

The Vac_in_meas curve 710B is an example of a measurement of a single-phase input voltage, such as at the input circuitry 102. The Iac_meas curve 720B is an example of a measurement of an AC current, such as measured based on AC current signal 116. The Vdc_out_meas curve 730B is an example of a measurement of a DC output voltage, such as measured between a first output terminal 104A and a second output terminal 104B. The Idc_out_meas curve 740B is an example of a measurement of a DC output voltage, such as measured between a first output terminal 104A and a second output terminal 104B.

As illustrated in FIG. 7B, the Iac_meas curve 720B may be for a time period of single cycle of a time period of 4 waves or waveform cycles. As described herein, the Iac_meas curve 720B on for one cycle may be associated with a switch 160 in an on state, such as during operation during a lower-power mode (e.g., 308). As illustrated, the on state of FIG. 7A may be a ratio of 1:3 of one waveform cycle on to three waveform cycles off. Alternatively, the ratio may be described as 1:4 of one waveform cycle on of a time period of 4 waveform cycles. While the Iac_meas curve 720B is on, the capacitor 170 is charged during the same time period(s) and/or waveform cycle(s). As illustrated with the Vdc_out_meas curve 730B and 740B, the capacitor discharges and provides a current and/or voltage to one or more loads. A charging-discharging cycle illustrated in FIG. 7B lasts 4 waveform cycles.

As illustrated in FIG. 7B, the Vac_in_meas curve 710B may have a time period of 4 cycles for switching on and off a switch 160. FIG. 7B illustrates that in the 3 periods that the switch 160 may be off there may be a voltage of that is not a flat curve of zero volts for an associated Vdc voltage (e.g., 730B). This may be due to, for example, a reactive current flowing that may be associated with the voltage illustrated during these 3 off cycles. An example of circuitry that may be associated with the reactive current(s) is a capacitive filter or the like. In various embodiments, the voltage may instead be zero during such off cycles. Additionally or alternatively, during one or more off cycles, the PFC converter controller 110 may set, provide, or generate an offset reference current that may cancel out or mitigate one or more currents present during the off cycles as illustrated in FIG. 7B. Such an offset reference current may cancel out the oscillation illustrated in the voltage of the Vac_in_meas curve 710B during off cycles.

As illustrated in FIG. 7B, the Idc_out_meas curve 740B may include one or more high frequency oscillations of the load current. For example, the on cycle illustrated in the Idc_out_meas curve 740B includes high frequency oscillators and, thus, is not clean flat curve or line. In various embodiments, such high frequency oscillations may be due to electronic load behavior. For example, this may be due to the load being a constant power load. In various embodiments, the Idc_out_meas curve 740B may, for on cycles, be a curve without high frequency oscillations. Thus the output at output terminals 104A, 104B may be provided to one or more loads without high frequency oscillations or with high frequency oscillations being compensated for in the PFC converter controller 110.

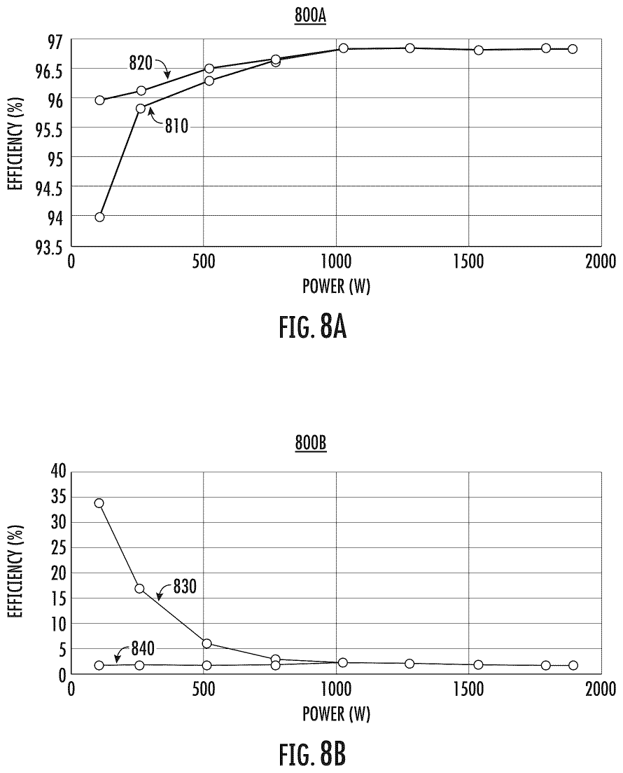

FIGS. 8A and 8B illustrate exemplary graphs for a PFC converter in accordance with one or more embodiments of the present disclosure.

FIG. 8A illustrates a first example graph 800A of the efficiency versus power for various embodiments of the present disclosure compared to a conventional PFC converter. Curve 810 is a curve associated with a conventional PFC converter. Curve 820 is an example of a curve associated with various embodiments of the present disclosure. As illustrated in graph 800A, the present disclosure provides improved efficiency when operating at low power (i.e., lower loading) than conventional PFC converters.

FIG. 8B illustrates a second example graph 800B of the total harmonic distortion of an output current (ITHD) versus power for various embodiments of the present disclosure compared to a conventional PFC converter. Curve 830 is a curve associated with a conventional PFC converter. Curve 840 is an example of a curve associated with various embodiments of the present disclosure. As illustrated in graph 800B, the present disclosure provides improved total harmonic distortion when operating at low power (i.e., lower loading) than conventional PFC converters.

In addition to lower THD, which is associated with lower or no harmonics in the current(s) in the circuitry of the PFC converter, there may be a reduction in the heat generated in the PFC converter. Harmonics in the PFC converter may cause heat to be generated in the circuitry of the PFC converter (e.g., 100, 500), particularly in inductors. The harmonics may be provided to the one or more loads at output circuitry 104 but, instead, may be circulating in the circuitry of the PFC converter, which may generate losses, such as heat. Reducing in THD allows for a reduction in the heat generated by one or more electrical components. For example, during off periods where the one or more switches 160 may be open, the inductor(s) may not conduct any current, particularly various embodiments with single-phase input circuitry (e.g., 102). That the energy input into a PFC converter is circulated as harmonics that does not get provided to one or more loads is associated with reduced efficiency. Thus the improvement of reduced THD is also associated with improved energy efficiency.

Additionally and/or alternatively, a reduction in THD may be associated with an improvement of the present disclosure of a reduction in acoustic noise. Harmonics in the system may create vibrations, particularly in inductors. The vibrations may lead to acoustic noise. For example, high frequency harmonics may generate magnetic fields that may generate micro vibrations that create acoustic noise. With reduced harmonics there may also be a reduction in acoustic noise, such as in inductors.

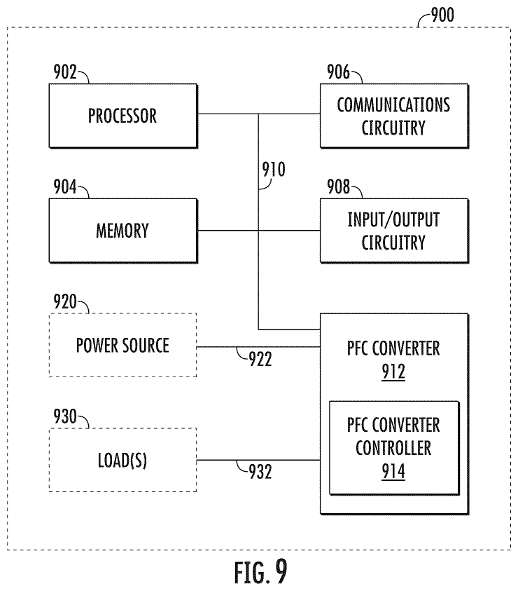

FIG. 9 illustrates an exemplary device in accordance with one or more embodiments of the present disclosure. The device 900 may be a device for an application, apparatus, and/or a system. For example, the device 900 may be an air conditioning systems or a device for another application, such those described herein. The device 900 illustrated may be a system and/or apparatus that includes a processor 902, memory 904, communications circuitry 906, input/output circuitry 908, PFC converter 912, and all of which may be connected by a bus or buses 910. Additionally the device 900 may include a power source 920 and/or a load(s) 930. Alternatively or additionally, a power source 920 and/or a load(s) 930 may be external to the device and coupled to the device 900. The power source 920 may be coupled to at least the PFC converter 912 via a bus or one or more connectors 922. The load(s) 930 may be coupled to at least the PFC converter 912 via bus or connectors 932. While FIG. 9 illustrates a bus and/or connectors, it will be readily appreciated that there may be multiple other connections.

The processor 902, although illustrated as a single block, may be comprised of a plurality of components and/or processor circuitry. The processor 902 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits. In various embodiments, the processor 902 may be configured to execute applications, instructions, and/or programs stored in the processor 902, memory 904, or otherwise accessible to the processor 902. When executed by the processor 902, these applications, instructions, and/or programs may enable the execution of one or a plurality of the operations and/or functions described herein. Regardless of whether it is configured by hardware, firmware/software methods, or a combination thereof, the processor 902 may comprise entities capable of executing operations and/or functions according to the embodiments of the present disclosure when correspondingly configured.

The memory 904 may comprise, for example, a volatile memory, a non-volatile memory, or a certain combination thereof. Although illustrated as a single block, the memory 904 may comprise a plurality of memory components. In various embodiments, the memory 904 may comprise, for example, a random access memory, a cache memory, a flash memory, a hard disk, a circuit configured to store information, or a combination thereof. The memory 904 may be configured to write or store data, information, application programs, instructions, etc. so that the processor 904 may execute various operations and/or functions according to the embodiments of the present disclosure. For example, in at least some embodiments, a memory 904 may be configured to buffer or cache data for processing by the processor 902. Additionally or alternatively, in at least some embodiments, the memory 904 may be configured to store program instructions for execution by the processor 902. The memory 904 may store information in the form of static and/or dynamic information. When the operations and/or functions are executed, the stored information may be stored and/or used by the processor 902.

The communication circuitry 906 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 904) and executed by a processor 902. In various embodiments, the communication circuitry 906 (as with other components discussed herein) may be at least partially implemented as part of the processor 902 or otherwise controlled by the processor 902. The communication circuitry 906 may communicate with the processor 902, for example, through a bus 910. Such a bus 910 may connect to the processor 902, and it may also connect to one or more other components of the processor 902. The communication circuitry 906 may be comprised of, for example, transmitters, receivers, transceivers, network interface cards and/or supporting hardware and/or firmware/software, and may be used for establishing communication with another component(s), apparatus(es), and/or system(s). The communication circuitry 906 may be configured to receive and/or transmit data that may be stored by, for example, the memory 904 by using one or more protocols that can be used for communication between components, apparatuses, and/or systems.

The input/output circuitry 908 may communicate with the processor 902 to receive instructions input by an operator and/or to provide audible, visual, mechanical, or other outputs to an operator. The input/output circuitry 908 may comprise supporting devices, such as a keyboard, a mouse, a user interface, a display, a touch screen display, lights (e.g., warning lights), indicators, speakers, and/or other input/output mechanisms. The input/output circuitry 908 may comprise one or more interfaces to which supporting devices may be connected. In various embodiments, aspects of the input/output circuitry 908 may be implemented on a device used by the operator to communicate with the processor 902. The input/output circuitry 908 may communicate with the memory 904, the communication circuitry 906, and/or any other component, for example, through a bus 910.

A PFC converter 912 receive power from a power source 920 and generate and/or provide power to load(s) 930. The PFC converter may be as described herein (e.g., 100, 500). The PFC converter may include a PFC converter controller 914, which may be as described herein (e.g., 110, 510). In various embodiments, the PFC converter controller 914 may be on or mounted to a PCB that is in a device 900.

The PFC converter controller 914 may be implement in hardware, software, or a combination of hardware and software. In various embodiments, the PDF controller may be embodied in an integrated circuit, an MCU (e.g., virtual machine running in an MCU), and/or the like. In various embodiments, the PFC converter controller 914 may be located externally to other circuitry of the PFC converter 912. In various embodiments, the PFC converter controller 914 may be configured to have, for example, a table that may be preprogrammed with a first efficiency threshold associated with the highest efficiency point 220, one or more on-off ratios, etc. Alternatively and/or additionally, the PFC converter controller 914 may be configured to determine and/or calculate the timing of the charging cycles and/or discharging cycles. For example, a next charging period during a charging-discharging cycle may be calculated with the ratio of waveform cycles to stay on and/or off, which may be an on-off ratio.

In various embodiments, the device 900 may be an air conditioner. The load 930 may be a motor for a compressor and/or a fan. The power source 920 may be a single-phase or a three-phase feed taken from an external power panel or power box. The PFC converter controller 912 may also control the motor of the compressor and/or fan. The PFC converter controller 912 may be configured to determine or predict a loading for the next charging-discharging cycle because the PFC converter controller 912 is controlling the motor(s) and, thus, controls the operation(s) of the motor is in one or more future periods. For example, the PFC converter controller 914 controls if the motor(s) is going to change speed or keep a current speed. Alternatively or additionally, the motor control may be by a standalone processor (e.g., 902), IC, MCU, or the like that may provide the PFC converter controller 914 with one or more signals associated with the motor control.

In various embodiments, the device 900 be used for battery charging. For example, one or more loads may be one or more batteries that may be charged. The device 900 may include a battery management system or, alternatively, the device 900 may receive and/or transmit one or more signals (e.g., one or more load signals 180) to a battery management system. Such a battery management system may provide, such as via one or more signals, a load profile of a charging profile associated with the load(s) of one or more batteries. The device 900 may operate the PFC converter 912 according to the received load profile to generate an output to charge the battery(ies).

Various embodiments may include a PFC converter that in a single channel topology or in multiple channel topology. Various embodiments of a multiple channel topology include a two-channel topology, which may be an interleaved PFC topology.

FIG. 10 illustrates an exemplary PFC converter configured with a two-channel PFC topology in accordance with one or more embodiments of the present disclosure. In various embodiments, a PFC converter 1000 may include input terminals 1002A, 1002 receiving one or more AC voltages and output terminals 104A, 104B for providing DC power to one or more loads. The input terminals 1002A, 1002B may be coupled to EMI filter(s) and rectification circuitry 1008, which may filter and/or rectify the AC signal signals received at input terminals 1002A, 1002B. The EMI filter(s) and rectification circuitry 1008 may provide a rectified AC signal measurement as an AC voltage input (Vac) signal 1012 to a PFC converter 1010. The EMI filter(s) and rectification circuitry 1008 may provide a rectified AC output signal to two or more channels, including a first channel and a second channel.

A first channel may include, as illustrated, a first channel inductor 1040A, a first channel diode 1050A, a first channel switch 1060A, and a first channel resistor 1036A. In various embodiments, the first channel current (Ich1) 1016A may be based on a sampled voltage at a point between the first channel switch 1060A and the first channel resistor 1036A and a known resistance of the first channel resistor 1036A from which this current is determined by the PFC converter controller 1010. In various embodiments,

A second channel may include, as illustrated, a second channel inductor 1040B, a second channel diode 1050B, a second channel switch 1060B, and a second channel resistor 1036B. In various embodiments, the second channel current (Ich2) 1016B may be based on a sampled voltage at a point between the second channel switch 1060B and the second channel resistor 1036B and a known resistance of the second channel resistor 1036B from which this current is determined by the PFC converter controller 1010.

The first and second channel may each be coupled at their respective outputs to one or more capacitors 170. The one or more capacitors 170 may be coupled to the output terminals 104A, 104B.

The PFC converter controller 1010 may receive multiple signals. For example, the PFC converter controller 1010 may receive an AC voltage input (Vac) signal 1012, a first channel current (Ich1) signal 1016A, a second channel current (Ich2) signal 1016B, a total current (Itot) signal 1019, and a DC voltage (Vbulk) signal 1014. In various embodiments the total current (Itot) signal 1019 may be measured in front of a resistor 1038, which may be referred to as a total resistor (Rtot). The PFC converter controller may utilize the received signals to generate one or more switch signals 1018. In various embodiments, the PFC converter controller may directly generate the switch signals 1018 and/or may utilize driver circuitry 1090 to generate the switch signals. For example, a first switch signal 1018A may be generated to operate a first channel switch 1060A and a second switch signal 1018B may be generated to operate a second channel switch 1060B.

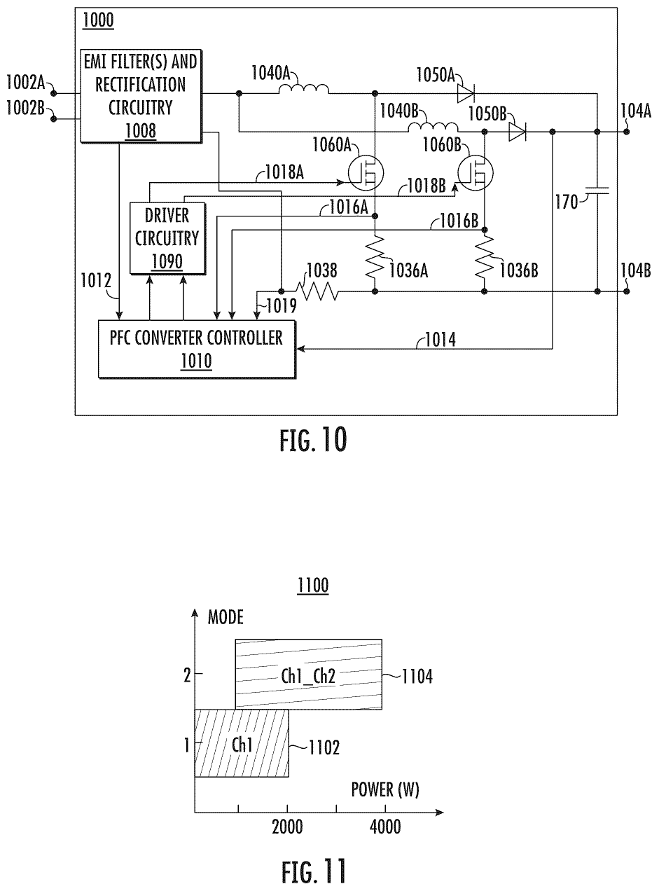

FIG. 11 illustrates an example graph associated with a PFC converter configured with a two-channel topology and at least two modes in accordance with one or more embodiments of the present disclosure. In various embodiments, a PFC converter (e.g., 1000) may be operated in two or more modes. The number of modes may be associated with the number of channels in a PFC converter topology. For example, as illustrated in FIG. 11, various embodiments may operate according toa first mode where only a first channel is operated and a second mode where a first channel and a second channel are operated at the same time. The operating mode may be associated with the power required by the one or more loads. While the power required is below a first threshold (e.g., 2000 W) the PFC converter may be operated in a first mode. While the power required is above the first threshold (e.g., 2000 W) then the PFC converter may be operated in a second mode of operating both the first channel and the second channel. As illustrated, each mode may be associated with a range of power that may be provided at the output terminals 104. When the power required may be in an overlap of the ranges for the first mode and second mode (e.g., between 1000 W and 2000 W), then the PFC converter may be operated in either the first mode or the second mode. In various embodiments, the selection of which mode to operate in when multiple modes are available may be associated with operating one or more of the channels at a highest efficiency (e.g., 220) associated with the channel(s).

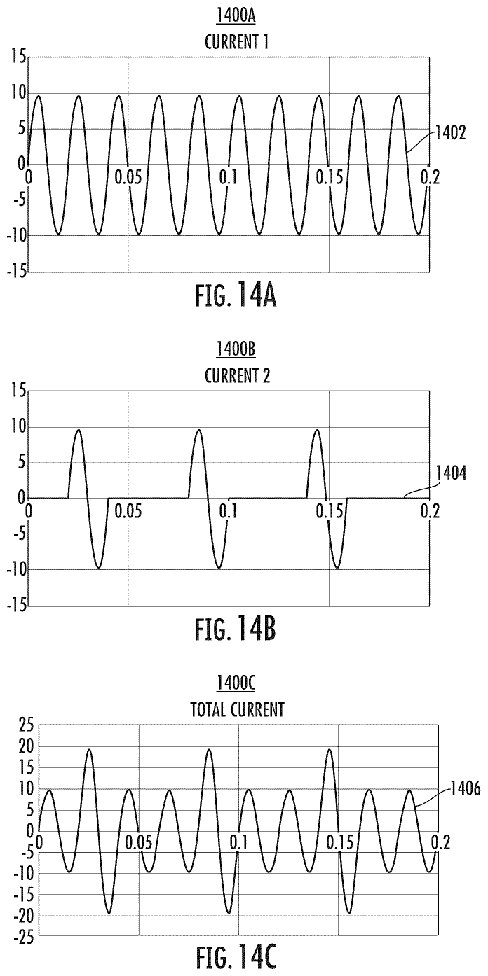

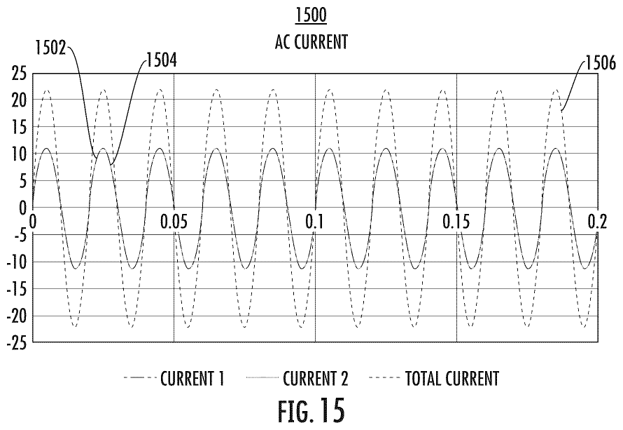

In various embodiments, the first channel may be associated with a first current and the second channel is associated with a second current, and the first current and the second current are not balanced or are not the same, such as described herein (e.g., FIGS. 14A-14C). Alternatively or additionally, in various embodiments, the first channel may be associated with a first current and the second channel is associated with a second current, and the first current and the second current are balanced or are the same, such as described herein (e.g., FIG. 15).

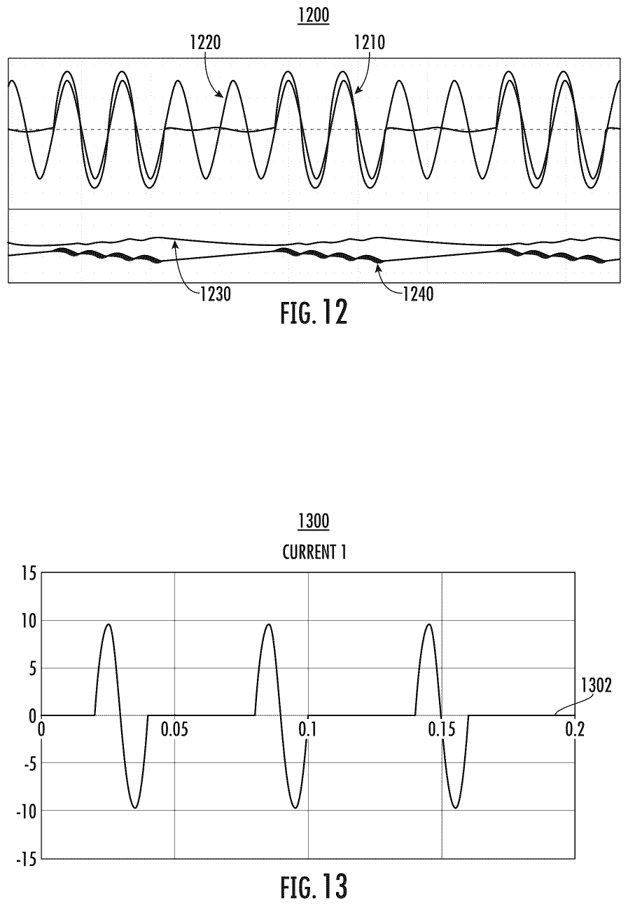

FIG. 12 illustrates exemplary graphs associated with a PFC converter configured with a two-channel topology in accordance with one or more embodiments of the present disclosure.

In various embodiments, a first mode may be associated with operating or enabling the first channel (or the second channel) while ethe second channel (or the first channel) is not operated or enabled. The operating or enabling of a channel is associated with enabling a switch (e.g., 1060A, 1060B) associated with the respective channel. In FIG. 12, there are multiple curves, including a Vac_in_meas curve 1210, an Iac_meas curve 1220, a Iac_meas curve 1230, and an Idc_out_meas curve 1240. The Vac_in_meas curve 1210 is an example of a measurement of a single-phase input voltage, such as at the input circuitry 1002. The Iac_meas curve 1220 is an example of a measurement of an AC current, such as measured at AC voltage input (Vac) signal al 1012. The Vdc_out_meas curve 1230 is an example of a measurement of a DC output voltage, such as measured between a first output terminal 104A and a second output terminal 104B. The Idc_out_meas curve 1240 is an example of a measurement of a DC output voltage, such as measured at total current (Itot) signal 1019.

FIG. 13 illustrate exemplary graphs of currents associated with a PFC converter configured with a two-channel topology operating in a first mode in accordance with one or more embodiments of the present disclosure. In various embodiments, a first mode may be associated with operating or enabling the first channel (or the second channel) while ethe second channel (or the first channel) is not operated or enabled. The operating or enabling of a channel is associated with enabling a switch (e.g., 1060A, 1060B) associated with the respective channel. As illustrated in FIG. 13, a first current may be provided to charge and/or discharge capacitor(s) 170 by operating or enabling a switch 1060A between ON and OFF. As illustrated, a switch 1060A may be operated to generate a first current 1302 by allowing one wave of a current to occur during a time period for operating the switch 1060A.

In various embodiments, for example, each of the first channel and the second channel may have a maximum power output of 2,000 W with a respective maximum efficiency point (e.g., 220) when operated at 1500 W. When a power required by one or more loads is lower than 1500 W a PFC converter with two channels (e.g., 1000) may be operated to only operate a first channel by operating and/or enabling switch 1060A. The waveform of a first may be, for example, as illustrated in FIG. 13.

FIGS. 14A-14C illustrate exemplary graphs of currents associated with a PFC converter configured with a two-channel topology operating in a second mode in accordance with one or more embodiments of the present disclosure. The first channel and a second channel may be operated simultaneously and each may have a different current. The first channel may have a first current, such as illustrated in FIG. 14A. The second channel may have a second current, such as illustrated in FIG. 14B.

FIG. 14A illustrates an exemplary graph of a first current. The exemplary graph 1400A illustrates a first current 1402 that is continuously running. This may be associated with a first switch 1060A being continuously enabled or ON/

FIG. 14B illustrates an exemplary graph of a second current. The exemplary graph 1400B illustrates a second current 1404 that is not continuously running. This may be associated with a second switch 1060B being intermittently by switching between ON and OFF.

FIG. 14C illustrates an exemplary graph of a summation of the first current and the second current. The exemplary graph 1400C illustrates a total current 1406 that is the summation of the first current 1402 and the second current 1406.

When operated in the second mode the PFC converter (e.g., 1000) may have the first channel and the second channel each working at a highest efficiency point (e.g., 220) associated with the respective channel.

In various embodiments, a PFC converter (e.g., 1000) may be operated according to the second mode with a continuously operated first channel and an intermittently operated second channel. For example, a load may be between 1500 W and 3000 W. The first channel may be operated to provide a first current associated with a power of 1500 W. The second channel may be operated to provide a second current associated with charging and discharging the capacitor with power associated with powering the amount of the load between 1500 W and 3000 W. Thus each channel may be operated at a highest efficiency.

FIG. 15 illustrates an exemplary graph of currents associated with a PFC converter configured with a two-channel topology operating in a balanced mode in accordance with one or more embodiments of the present disclosure. For example, a PFC converter (e.g., 1000) may be operated with a first current 1502 associated with a first channel and a second current 1504 associated with a second channel both being provided in a continuous mode where the first channel and the second channel are balanced. When balanced, each channel shares the same amount of current that are in phase (i.e., the currents in each channel are equal). Thus the total AC current being utilized by the PFC converter is illustrated as total current 1506.

While a multi-channel topology of a two-channel topology is described herein, it will be appreciated that more than two channels may be used. For example, a PFC topology may have three or more channels.

Embodiments of the present disclosure may be implemented in various embodiments. It should be readily appreciated that the embodiments of the systems, apparatuses, and methods described herein may be configured in various additional and alternative manners in addition to those expressly described herein.

### CONCLUSION

Operations and/or functions of the present disclosure have been described herein, such as in flowcharts. As will be appreciated, one or more operations may be computer program instructions that may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A power factor correction converter comprising:
an input circuitry to receive at least an input voltage;
an output circuitry to provide an output voltage;
a boost circuitry electrically coupled to the input circuitry and to the output circuitry, wherein the boost circuitry comprises at least one capacitor;
at least one switch, wherein the at least one switch is in the input circuitry or the boost circuitry, wherein the at least one switch is configured to operate in at least two states including an on state and an off state, wherein operating in the on state causes the boost circuitry to charge the at least one capacitor and wherein operating in the off state causes the at least one capacitor to discharge; and
a power factor correction converter controller configured to control the at least one switch to change states between the on state and the off state at a first ratio, wherein the first ratio is associated one or more time periods for the on state and one or more periods for the off state and also with a first efficiency threshold associated with the on state.

2. The power factor correction converter of claim 1, wherein the first efficiency threshold is associated with an optimal power factor efficiency.

3. The power factor correction converter of claim 1, wherein the input voltage comprises a single-phase voltage input.

4. The power factor correction converter of claim 1, wherein the input voltage comprises a three-phase voltage input.

5. The power factor correction converter of claim 1, wherein the power factor correction converter controller is further configured to determine the first ratio based on a current load associated with the power factor correction converter.

6. The power factor correction converter of claim 1, wherein the power factor correction converter controller is further configured to determine the first ratio based on a predicted load.

7. The power factor correction converter of claim 1, wherein the power factor correction converter controller is further configured to determine the first ratio based on a load profile.

8. A system comprising:
a power source;
a load;
a power factor correction converter comprising:
an input circuitry coupled to the power source and configured to receive an input voltage from the power source;
an output circuitry coupled to the load and configured to provide an output voltage to the load;
a boost circuitry electrically coupled to the input circuitry and to the output circuitry, wherein the boost circuitry comprises at least one capacitor;
at least one switch, wherein the at least one switch is in the input circuitry or the boost circuitry, wherein the at least one switch is configured to operate in at least two states including an on state and an off state, wherein operating in the on state causes the boost circuitry to charge the at least one capacitor and wherein operating in the off state causes the at least one capacitor to discharge; and
a power factor correction converter controller configured to control the at least one switch to change states between the on state and the off state at a first ratio, wherein the first ratio is associated one or more time periods for the on state and one or more periods for the off state and also with a first efficiency threshold associated with the on state.

9. The system of claim 8, wherein the first efficiency threshold is associated with an optimal power factor efficiency.

10. The system of claim 8, wherein the voltage input comprises a single-phase input voltage.

11. The system of claim 8, wherein the voltage input comprises a three-phase input voltage.

12. The system of claim 8, wherein the power factor correction converter controller is further configured to determine the first ratio based on a current load associated with the power factor correction converter.

13. The system of claim 8, wherein the power factor correction converter controller is further configured to determine the first ratio based on a predicted load.

14. The system of claim 8, wherein the power factor correction converter controller is further configured to determine the first ratio based on a load profile.

15. A method comprising:
providing a power factor correction converter comprising an input circuitry, an output circuitry, a boost circuitry, at least one switch, and a power factor correction converter controller, wherein the input circuitry is coupled to a power source, wherein the output circuitry is coupled to a load, wherein the boost circuitry is coupled to the input circuitry and the output circuitry, and wherein the boost circuitry comprises at least one capacitor, wherein the at least one switch is in the input circuitry or the boost circuitry; and
operating the at least one switch to change states between an on state and an off state based on a first ratio, wherein operating in the on state causes the boost circuitry to charge the at least one capacitor and wherein operating in the off state causes the at least one capacitor to discharge, and wherein the first ratio is associated one or more time periods for the on state and one or more periods for the off state and also with a first efficiency threshold associated with the on state.

16. The method of claim 15, wherein the first efficiency threshold is associated with an optimal power factor efficiency.

17. The method of claim 15, wherein the voltage input comprises a single-phase input voltage.

18. The method of claim 15, wherein the voltage input comprises a three-phase input voltage.

19. The method of claim 15, further comprising:
determining, with the power factor correction converter controller, the first ratio based on a current load associated with the power factor correction converter.

20. The method of claim 15 further comprising:
determining, with the power factor correction converter controller, the first ratio based on a load profile.
